(19) United States
(12) Patent Application Publication
(10) Pub. No.: US 2025/0220284 A1
(43) Pub. Date: Jul. 3, 2025

(54) OPTIMIZING AUTOMATIC CONTENT RECOGNITION QUERIES BASED ON CONTENT UNDERSTANDING

(71) Applicant: Roku, Inc., San Jose, CA (US)

(72) Inventors: Shashank Merchant, Sunnyvale, CA (US); Virginie M. Debelair, San Francisco, CA (US); Yathindran Parthasarathy, San Jose, CA (US); Wim Michiels, San Jose, CA (US)

(21) Appl. No.: 18/401,438

(22) Filed: Dec. 30, 2023

(51) Int. Cl. H04N 21/845; H04N 21/235

(52) U.S. Cl. CPC H04N 21/8456; H04N 21/2353

(57) ABSTRACT

Disclosed herein are system, apparatus, article of manufacture, method and/or computer program product embodiments, and/or combinations and sub-combinations thereof, for processing, understanding, and defining media content. An example process can include receiving metadata corresponding to a media stream requested for playback by an application on a media device, wherein the media stream includes a plurality of media content items; determining, based on the metadata, one or more playback properties associated with the plurality of media content items within the media stream; identifying, based on the one or more playback properties, at least one targeted media content item from the plurality of media content items; determining a playback time for the at least one targeted media content item; and obtaining, during the playback time, a fingerprint corresponding to the at least one targeted media content item.

### FIELD

This disclosure is generally directed to streaming media content, and more particularly, to optimizing automatic content recognition queries based on understanding of the media content.

### SUMMARY

Provided herein are system, apparatus, article of manufacture, method and/or computer program product embodiments, and/or combinations and sub-combinations thereof, for optimizing automatic content recognition queries.

In some aspects, a method is provided for processing media content and/or metadata associated with the media content to optimize automatic content recognition queries. The method can operate in a media device that is used to present or playback the media content (e.g., using a display device is communicatively coupled to the media device). In some cases, the media device may be configured to execute one or more software applications that can be used to access the media content.

The method can operate by receiving metadata corresponding to a media stream requested for playback by an application on a media device, wherein the media stream includes a plurality of media content items. Based on the metadata, one or more playback properties associated with the plurality of media content items in the media stream can be identified. Based on the one or more playback properties, at least one targeted media content item from the plurality of media content items can be identified. A playback time for the at least one targeted media content item can be determined. A fingerprint corresponding to the at least one targeted media content item can be obtained during the playback time.

In some aspects, a system is provided for processing media content and/or metadata associated with the media content to optimize automatic content recognition queries. The system can include one or more memories and at least one processor coupled to at least one of the one or more memories and configured to receive metadata corresponding to a media stream requested for playback by an application on a media device, wherein the media stream includes a plurality of media content items. The at least one processor of the system can be configured to determine, based on the metadata, one or more playback properties associated with the plurality of media content items within the media stream. The at least one processor of the system can also be configured to identify, based on the one or more playback properties, at least one targeted media content item from the plurality of media content items. The at least one processor of the system can also be configured to determine a playback time for the at least one targeted media content item. The at least one processor of the system can also be configured to obtain, during the playback time, a fingerprint corresponding to the at least one targeted media content item.

In some aspects, a non-transitory computer-readable medium is provided for processing media content and/or metadata associated with the media content to optimize automatic content recognition queries. The non-transitory computer-readable medium can have instructions stored thereon that, when executed by at least one computing device, cause the at least one computing device to receive metadata corresponding to a media stream requested for playback by an application on a media device, wherein the media stream includes a plurality of media content items. The instructions of the non-transitory computer-readable medium can, when executed by the at least one computing device, cause the at least one computing device to determine, based on the metadata, one or more playback properties associated with the plurality of media content items within the media stream. The instructions of the non-transitory computer-readable medium also can, when executed by the at least one computing device, cause the at least one computing device to identify, based on the one or more playback properties, at least one targeted media content item from the plurality of media content items. The instructions of the non-transitory computer-readable medium also can, when executed by the at least one computing device, cause the at least one computing device to determine a playback time for the at least one targeted media content item. The instructions of the non-transitory computer-readable medium also can, when executed by the at least one computing device, cause the at least one computing device to obtain, during the playback time, a fingerprint corresponding to the at least one targeted media content item.

### BRIEF DESCRIPTION OF THE FIGURES

The accompanying drawings are incorporated herein and form a part of the specification.

FIG. 1 illustrates a block diagram of a multimedia environment, according to some examples of the present disclosure.

FIG. 2 illustrates a block diagram of a streaming media device, according to some examples of the present disclosure.

FIG. 3 is a diagram illustrating an example system for optimizing automatic content recognition queries, according to some examples of the present disclosure;

FIG. 4 is a diagram illustrating a flowchart of an example method for optimizing automatic content recognition queries, according to some examples of the present disclosure;

FIG. 5 is a diagram illustrating a flowchart of another example method for optimizing automatic content recognition queries, according to some examples of the present disclosure;

FIG. 6 is a diagram illustrating a flowchart of another example method for optimizing automatic content recognition queries, according to some examples of the present disclosure;

FIG. 7 is a diagram illustrating an example of a neural network architecture, according to some examples of the present disclosure; and

FIG. 8 illustrates an example computer system that can be used for implementing various aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Users can generally access and consume videos using client devices such as, for example and without limitation, smart phones, set-top boxes, desktop computers, laptop computers, tablet computers, televisions (TVs), IPTV receivers, media devices, monitors, projectors, smart wearable devices (e.g., smart watches, smart glasses, head-mounted displays (HMDs), etc.), appliances, and Internet-of-Things (IoT) devices, among others. The videos can include, for example, live video content broadcast by a content server(s) to the client devices, pre-recorded video content available to the client devices on-demand, streaming video content, etc. In some instances, the videos can be customized for one or more users/audiences, geographic areas, devices, markets, demographics, etc. Moreover, the videos can be adjusted to include additional content such as targeted media content. The targeted media content can include, for example, one or more frames (e.g., one or more video frames and/or still images), audio content, text content, closed-caption content, customized content, and/or any other content.

In some cases, client devices can be configured to implement automatic content recognition (ACR). That is, a client device can sample media content that is played using the client device to generate a unique fingerprint or signature that can be used to identify the media content by comparing the fingerprint to a database of known fingerprints. In some cases, the client device may have a local database that can be used to compare the fingerprint obtained from the media content while in other cases the client device may send the fingerprint to a server that can perform the comparison in order to identify the media content.

Implementing automatic content recognition can be burdensome for the client device, the server, and/or the network. For example, regular, periodic sampling of the media content to obtain fingerprints can use significant computing resources (e.g., processor and/or memory resources). Also, significant computing resources are also expended at the server side in order to process all of the fingerprints received from the client devices, which can increase the costs associated with implementing ACR.

In addition to the potential network and computing issues described above, in some cases it may be desirable to selectively perform automatic content recognition based on a type or classification of a media content item. For example, it may be desirable to perform automatic content recognition on particular segments of a media content item or during presentation (e.g., playback) of targeted media content items. However, current implementations are not able to identify the types of media content in order to selectively perform automatic content recognition.

Provided herein are system, apparatus, device, method and/or computer program product embodiments, and/or combinations and sub-combinations thereof, for optimizing automatic content recognition queries. In some examples, a system such as a client device can identify portions of a media stream that include targeted media content items. In some aspects, the client device can perform automatic content recognition during those portions of the media stream that include the targeted media content item(s). In some cases, the client device can disable automatic content recognition during remaining portions of the media stream (e.g., portions that do not include targeted media content). In some configurations, such selective implementation of automatic content recognition can improve performance of the multimedia environment (e.g., client device, the servers, the network, etc.).

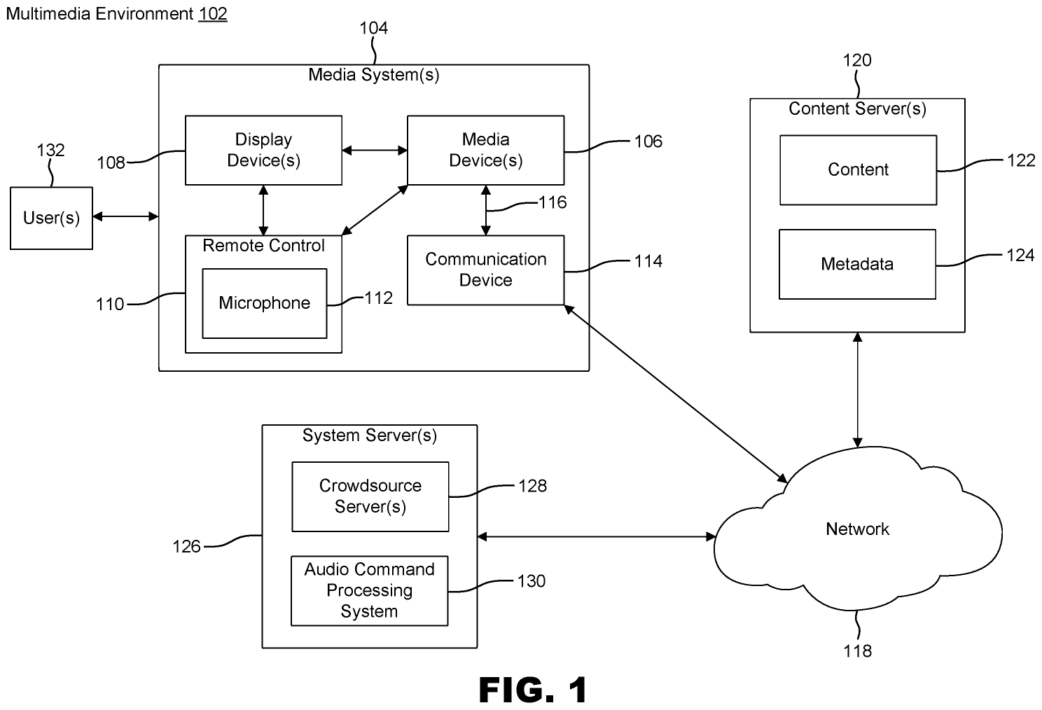

Various embodiments, examples, and aspects of this disclosure may be implemented using and/or may be part of a multimedia environment 102 shown in FIG. 1. It is noted, however, that multimedia environment 102 is provided solely for illustrative purposes and is not limiting. Examples and embodiments of this disclosure may be implemented using, and/or may be part of, environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some examples, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various examples, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In some examples, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources). Although only one content server 120 is shown in FIG. 1, in practice, the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, targeted media content, software, and/or any other content or data objects in electronic form.

In some examples, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining to or relating to the content 122. Metadata 124 may also or alternatively include one or more indexes of content 122, such as but not limited to a trick mode index. In one illustrative example, metadata 124 may include one or more manifest files (e.g., XML files) that include metadata that is associated with a video stream such as, for instance, a dynamic adaptive streaming over HTTP (DASH) media stream or a HTTP live streaming (HLS) media stream.

In some examples, the content server 120 or the media device 106 can process content 122 and/or metadata 124 to identify portions of content 122 that include targeted media content. As used herein, targeted media content may include any type of media content (e.g., video content, image content, audio content, text content, etc.) that promotes or is otherwise associated with a product, service, brand, and/or event. In some configurations, content server 120 or media device 106 can identify targeted media content within content 122 based on metadata 124. For instance, metadata 124 can be used to derive one or more playback properties associated with content 122 such as playback duration; content server address(es) (e.g., uniform resource locator(s) URLs); closed-captioning content; encryption status; etc. In some cases, media device 106 or content sever 120 can use one or more of the playback properties (e.g., based on metadata 124) to identify portions of content 122 that correspond to targeted media content.

In some examples, the content server 120 or the media device 106 can process media content segments to extract features and information, such as contextual information, from the media content segments and classify the media content segments based on the extracted features and information. In some examples, the content server 120 or the media device 106 can determine and/or extract information (e.g., contextual information, content information and/or attributes, segment characteristics, etc.) about one or more segments of media content, and use the information to categorize the one or more segments of the media content. In some configurations, the content server 120 or the media device 106 can use the extracted information (e.g., contextual information) to classify portions of content 122 as targeted media content.

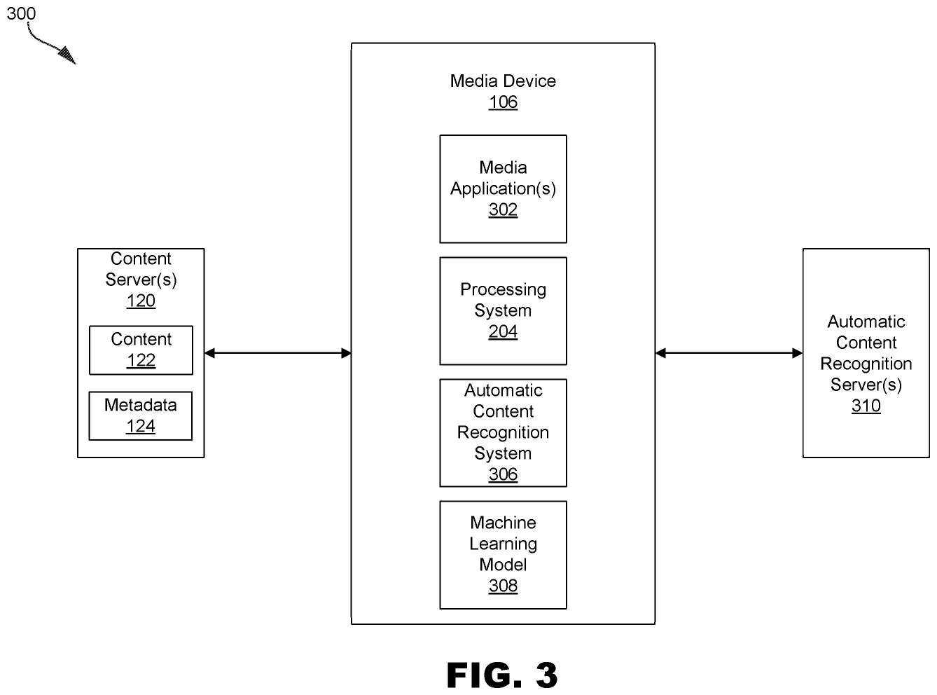

In some aspects, media device 106 can selectively perform automatic content recognition (ACR) based on whether content 122 corresponds to targeted media content. That is, media device 106 can collect information associated with targeted media content to generate a fingerprint that can be used for ACR. In some aspects, media devices 106 can perform fingerprint matching associated with ACR locally (e.g., media devices 106 can compare the obtained fingerprint with local database of fingerprints). Alternatively, or in addition, media devices 106 may send fingerprint data to a remote server (e.g., systems servers 126, content servers 120, and/or ACR servers as described below in connection with FIG. 3) that can perform fingerprint matching associated with ACR remotely.

In some cases, selective implementation of ACR (e.g., performing ACR on media content that corresponds to targeted media content) can improve operation of media device 106 by reducing the compute resources used therein (e.g., reduce processor load, reduce memory utilization, etc.). In addition, selective implementation of ACR can reduce bandwidth utilization by minimizing the number of ACR queries that are sent to remote or back-end servers (e.g., system servers 126). Moreover, a reduction of ACR queries will also improve the operation of such servers.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126. As noted above, in some cases system servers 126 may be configured to perform one or more functions associated with ACR. For instance, media devices 106 can send fingerprint(s) to system servers 126, and system servers 126 may compare the received fingerprint(s) with a fingerprint database in order to identify the associated media content.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streaming of the movie.

The system servers 126 may also include an audio command processing system 130. As noted above, the remote control 110 may include a microphone 112. The microphone 112 may receive audio data from users 132 (as well as other sources, such as the display device 108). In some examples, the media device 106 may be audio responsive, and the audio data may represent verbal commands from the user 132 to control the media device 106 as well as other components in the media system 104, such as the display device 108.

In some examples, the audio data received by the microphone 112 in the remote control 110 is transferred to the media device 106, which is then forwarded to the audio command processing system 130 in the system servers 126. The audio command processing system 130 may operate to process and analyze the received audio data to recognize the user 132's verbal command. The audio command processing system 130 may then forward the verbal command back to the media device 106 for processing.

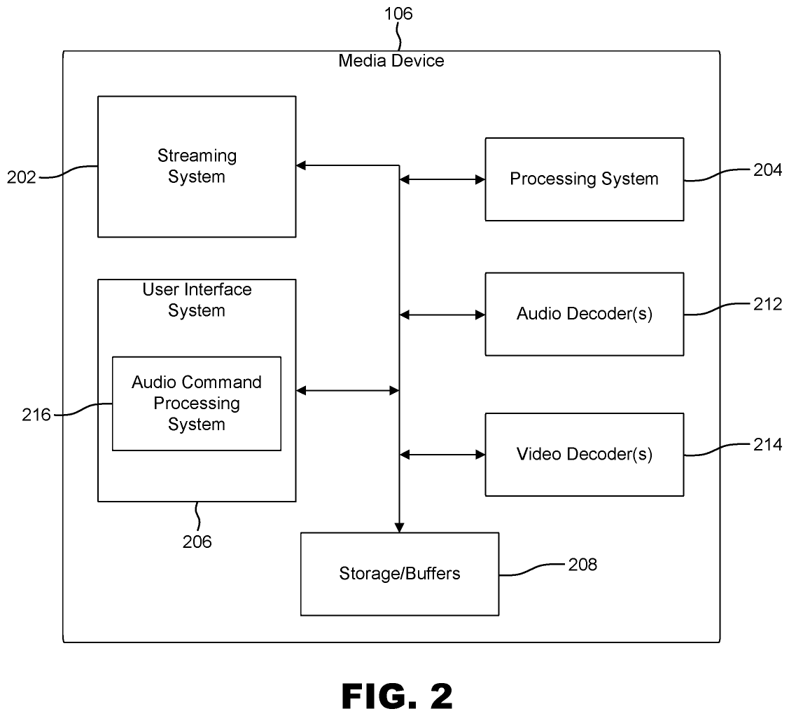

In some examples, the audio data may be alternatively or additionally processed and analyzed by an audio command processing system 216 in the media device 106 (see FIG. 2). The media device 106 and the system servers 126 may then cooperate to pick one of the verbal commands to process (either the verbal command recognized by the audio command processing system 130 in the system servers 126, or the verbal command recognized by the audio command processing system 216 in the media device 106).

FIG. 2 illustrates a block diagram of an example media device 106, according to some embodiments. Media device 106 may include a streaming system 202, processing system 204, storage/buffers 208, and user interface module 206. As described above, the user interface module 206 may include the audio command processing system 216.

The media device 106 may also include one or more audio decoders 212 and one or more video decoders 214. Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples. The media device 106 can implement other applicable decoders, such as a closed caption decoder.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OPla, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to, H.263, H.264, H.265, VVC (also referred to as H.266), AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some examples, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming system 202 of the media device 106 may request the selected content from the content server(s) 120 over the network 118. The content server(s) 120 may transmit the requested content to the streaming system 202. The media device 106 may transmit the received content to the display device 108 for playback to the user 132.

In streaming examples, the streaming system 202 may transmit the content to the display device 108 in real time or near real time as it receives such content from the content server(s) 120. In non-streaming examples, the media device 106 may store the content received from content server(s) 120 in storage/buffers 208 for later playback on display device 108.

### Optimizing Automatic Content Recognition Queries

Referring to FIG. 1, content server(s) 120 and media devices 106 can be configured to perform applicable functions related to optimizing automatic content recognition (ACR) queries. For example, content server(s) 120 and/or media devices 106 can evaluate content 122 to classify or identify different portions of content 122. In some cases, content server(s) 120 and/or media devices 106 can implement one or more algorithms (e.g., heuristic-based algorithms, rule-based algorithms, machine learning models, etc.) that can be used to classify or identify portions of content 122. In some aspects, ACR can be selectively performed on portions of content 122 based on the classification.

In some aspects, content server(s) 120 and/or media devices 106 can classify one or more portions of content 122 as targeted media content. As noted above, targeted media content can include video, audio, image, text, etc. that is associated with a product, service, brand, and/or event. In some cases, content server(s) 120 and/or media devices 106 can identify targeted media content within content 122 based on metadata 124. For instance, metadata 124 may include one or more presentation time stamps that can be used to identify discontinuities within a media stream. In some cases, the metadata (e.g., presentation time stamps) can be used to determine a playback duration that can be used to identify a portion of content 122 that corresponds to a targeted media content item. Further examples regarding the use of metadata 124 for identifying targeted media content are discussed below with respect to FIG. 3.

In some examples, media devices 106 can be configured to selectively perform ACR based on the identification of targeted media content. That is, media devices 106 can obtain data (e.g., fingerprint(s)) during playback of content 122 that includes targeted media content. In some aspects, media devices 106 can perform fingerprint matching associated with ACR locally (e.g., compare with local database of fingerprints). Alternatively, or in addition, media devices 106 may send fingerprint data to a remote server (e.g., systems servers 126 or content servers 120) that can perform fingerprint matching associated with ACR remotely. Thus, performance of multimedia environment 102 can be improved based on optimization of ACR queries (e.g., reduce bandwidth utilization based on reduced number of queries sent via network 118; reduce usage of compute resources on media devices 106; reduce usage of compute resources on system servers 126; etc.).

The disclosure now continues with a further discussion of identifying scene breaks/boundaries in media content.

FIG. 3 is an example of a system 300 that can be used to optimize automatic content recognition (ACR) queries. In some examples, system 300 can include media device 106 (as described in connection with FIG. 1 and FIG. 2 above). In some aspects, media device 106 can include one or more media applications 302. In some configurations, the media applications 302 may include software that is configured to operate within media device 106. For example, media applications 302 can be installed and execute within a software environment (e.g., operating system) of media device 106 and provide software that can be used to access content 122 from one or more content servers 120.

In some examples, content 122 from content servers 120 may include any combination of music, videos, movies, TV programs, multimedia, images, still pictures, text, graphics, gaming applications, advertisements, programming content, public service content, government content, local community content, targeted media content, software, and/or any other content or data objects in electronic form. In addition, metadata 124 from content servers 120 can include any type of data that is associated with content 122. For instance, metadata 124 can include indexes of content 122; links for accessing content 122; encoding information for content 122; encryption information for content 122; presentation time stamp(s) for content 122; closed-caption data for content 122; descriptive data associated with content 122 (e.g., writer, director, artist, date, etc.); any other type of data associated with content 122; and/or any combination thereof.

In some aspects, content 122 may include a media stream that is configured for playback using mobile device 106 (e.g., via media applications 302). In some cases, the media stream may utilize a streaming protocol such as HTTP live streaming (HLS), dynamic adaptive streaming over HTTP (DASH), web real-time communications (WebRTC), real-time streaming protocol (RTSP), and/or any other protocol suitable for streaming content 122. In some configurations, the metadata 124 can include one or more files that include data that can be used by media device 106 for playback of content 122. In some cases, these files may be referred to as manifest files. In one illustrative example, the format of a manifest file may be an extensible markup language (XML), although alternative file formats are contemplated herein.

In some configurations, media device 106 may include a processing system 204. In some aspects, processing system 204 can be configured to process content 122 and/or metadata 124. In some cases, processing system 204 can use metadata 124 to identify or categorize different portions of content 122. For example, processing system 204 may process metadata 124 to identify portions of content 122 that correspond to targeted media content (e.g., media content that is associated with a product, brand, service, event, etc.).

In some cases, processing system 204 may identify that a portion of content 122 corresponds to targeted media content by detecting a discontinuity within content 122. In some aspects, the discontinuity can correspond to a flag or indication within metadata 124 that signifies a switch or transition between media items or media samples within content 122. For instance, a manifest file associated with a media stream can be used to identify a discontinuity within the media stream. In some cases, processing system 204 can determine that a content item that is scheduled for playback before or after a discontinuity corresponds to a targeted media content item.

In some examples, processing system 204 can use metadata 124 to determine one or more presentation time stamp (PTS) values associated with different items within content 122. In some aspects, processing system 204 can use PTS values and/or other metadata 124 related to timing to determine the playback duration for media content items within a content stream (e.g., content 122). In some cases, processing system 204 can identify a targeted media content item based on its playback duration. For instance, processing system 204 may identify a targeted media content item when the playback duration is relatively short as compared to a preceding or a subsequent media content item. In one illustrative example, the targeted media content item may have a playback duration that is 25% or less than an adjacent media content item (e.g., preceding media content item has a 5-minute playback duration and targeted media content item has a 45 second playback duration, which is 15% of the playback duration for the preceding media content item).

In some instances, processing system 204 can identify a targeted media content item when the playback duration is equivalent to an expected playback duration value (e.g., 15 seconds, 30 seconds, 45 seconds, or 1 minute). In some cases, processing system 204 can identify a targeted media content item when the playback duration is less than a maximum threshold value (e.g., playback duration is less than or equal to 2 minutes).

In some configurations, processing system 204 may identify that a portion of content 122 corresponds to targeted media content based on the link or address (e.g., uniform resource locator (URL)) associated with the portion of the media stream. For example, metadata 124 may include different links or addresses for different portions of a media stream. In some cases, processing system 204 may parse the address to determine whether it is associated with a content server 120 that is configured to provide targeted media content items. In some examples, media device 106 may include a database of addresses that can be compared to the link or address from metadata 124 to identify targeted media content items.

In some examples, processing system 204 may identify that a portion of content 122 corresponds to targeted media content based on an encryption state. For instance, metadata 124 may identify portions of content 122 that are encrypted and may also provide data that can be used to unencrypt the encrypted portions. In some instances, processing system 204 may determine that a portion of content 122 that is not encrypted corresponds to a targeted media content item. Alternatively, or in addition, the processing system 204 can determine that portions of content 122 that are encrypted do not correspond to targeted media content items.

In some configurations, processing system 204 may identify that a portion of content 122 corresponds to targeted media content based on the presence of corresponding closed-caption data. That is, processing system 204 may determine that a portion of content 122 that does not have corresponding closed-caption data corresponds to a targeted media content item. Alternatively, or in addition, the processing system 204 can determine that portion of content 122 that have corresponding closed-caption data do not correspond to targeted media content items.

In some aspects, media device 106 can include a machine learning (ML) model 308 that can be configured to identify portions of content 122 that correspond to targeted media content items. In some cases, ML model 308 may receive content 122 and/or metadata 124 as input, and ML model 308 can output one or more indicators that identify portions of content 122 that correspond to targeted media content items. In some cases, ML model 308 may also output a confidence score that can be associated with a prediction of a targeted media content item.

In some cases, ML model 308 can be trained to identify one or more contextual features from content 122. In some aspects, the contextual features can include a type and/or genre of content, a type of scene, a background and/or setting, any activity and/or events, an actor or actors, demographic information, a mood and/or sentiment, a type of audio or lack thereof, any objects, noise levels, a landmark and/or architecture, a geographic location, a keyword, a message, a type of encoding, a time and/or date, any other characteristic associated with media content 122, and/or any combination thereof. In some examples, ML model 308 can be trained to identify targeted media content items based on the contextual features. For example, ML model 308 may identify a targeted media content item based on the inclusion of an actor that is not present in a preceding portion of the content 122. In another example, ML model 308 may identify a targeted media content item based on a mood or setting during a portion of content 122 that is inconsistent with an adjacent portion of content 122.

In some aspects, media device 106 can include an automatic content recognition (ACR) system 306. In some examples, ACR system 306 can be configured to obtain one or more fingerprints (e.g., identifiers, signatures, etc.) that correspond to content 122. A fingerprint can refer to a data sample or a sequence of features that can be used to identify image content, video content, and/or audio content associated with content 122. In some cases, a fingerprint can include at least one unique identifier corresponding to at least one image frame of a media stream. For example, the unique identifier may be a value (e.g., pixel value, binary value, integer, vector, etc.), an alphanumeric representation, and/or a compressed version of content 122.

In some examples, a fingerprint can be used to identify a portion of content 122. For instance, ACR system 306 may include a local fingerprint database that can be used to compare against the fingerprints that are captured from content 122. In some cases, ACR system 306 may determine that there is a match or correspondence between an obtained fingerprint and a fingerprint in the database (e.g., previously available reference fingerprint). In some examples, the match or correspondence between the obtained fingerprint and the stored fingerprint can be based on a comparison that yields a match or a substantial match (e.g., greater than a minimum threshold). Upon determining that there is a match, ACR system 306 can identify the content 122. In one illustrative example, ACR system 306 may compare a fingerprint from content 122 with fingerprints in a local fingerprint database to identify that content 122 corresponds to a targeted media content item for a particular brand of soda.

In some instances, ACR system 306 may send the fingerprint to one or more ACR servers 310. In some configurations, the one or more ACR servers 310 can be part of systems servers 126 and/or content servers 120. Alternatively, in some examples, ACR servers 310 can be separate or dedicated servers that are configured to receive and process fingerprint(s) (e.g., perform fingerprint matching). In some cases, the one or more ACR servers 310 can include one or more additional fingerprint databases that can be used to compare against the fingerprint obtained by ACR system 306. In some examples, the ACR server 310 may identify content 122 based on determining that that there is a match or correspondence between the fingerprint from ACR system 306 and a fingerprint in one of the fingerprint databases.

In some cases, ACR system 306 can be configured to obtain fingerprints while streaming one or more portions of content 122. For example, ACR system 306 can be configured to obtain fingerprints during playback of one or more targeted media content items (e.g., as identified by processing system 204 and/or ML model 308). In one illustrative example, processing system 204 may determine that a targeted media content item is scheduled to be presented (e.g., played) between the 6-minute mark and the 7-minute mark of a media stream (e.g., content 122), and media device 106 can configure ACR system 306 to obtain a fingerprint at or about the 6:30 mark, which can then be used (e.g., locally ACR system 306 or remotely by ACR servers 310) to identify the targeted media content item.

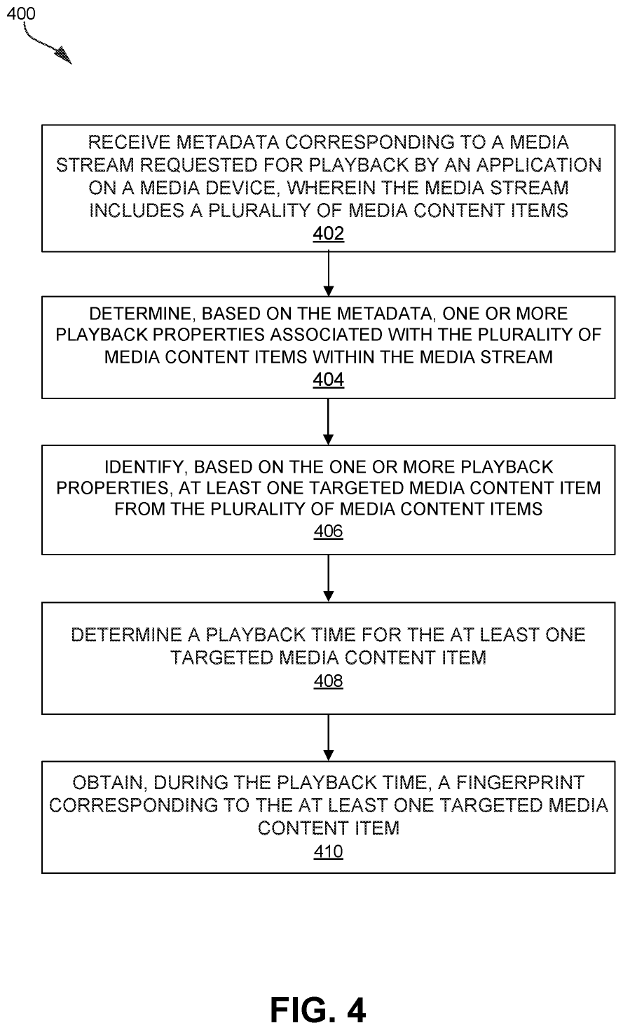

FIG. 4 is a flowchart for a method 400 for optimizing automatic content recognition queries. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art.

Method 400 shall be described with reference to FIG. 3. However, method 400 is not limited to that example.

In step 402, the method 400 includes receiving metadata corresponding to a media stream requested for playback by an application on a media device, wherein the media stream includes a plurality of media content items. For instance, media device 106 can receive metadata 124 corresponding to content 122 for playback by media application 302, and content 122 can include a plurality of media content items. In some examples, the metadata can include a manifest file. In some instances, the media stream can correspond to at least one of a dynamic adaptive streaming over HTTP (DASH) format and a HTTP live streaming (HLS) format.

In step 404, the method 400 includes determining, based on the metadata, one or more playback properties associated with the plurality of media content items within the media stream. For example, media device 106 can include a processing system 204 that is configured to determine one or more playback properties for content 122 based on metadata 124.

In step 406, the method 400 includes identifying, based on the one or more playback properties, at least one targeted media content item from the plurality of media content items. For instance, processing system 204 can identify a portion (e.g., section, sample, etc.) of content 122 that includes a targeted media content item.

In step 408, the method 400 includes determining a playback time for the at least one targeted media content item. For example, processing system 204 can determine a playback time (e.g., time slot, time window, etc.) for the portion of content 122 that includes the targeted media content item.

In step 410, the method 400 includes obtaining, during the playback time, a fingerprint corresponding to the at least one targeted media content item. For instance, automatic content recognition (ACR) system 306 of media device 106 can be configured to obtain a fingerprint for the portion of content 122 that includes the targeted media content item during the playback time that is associated with that portion of content 122.

In some examples, the method 400 can include matching the fingerprint corresponding to the at least one targeted media content item with a known fingerprint from a plurality of fingerprints stored on a database of targeted media content items. For example, ACR system 306 may include a database that includes a plurality of fingerprints that are each associated with a targeted media content item. ACR system 306 can use the fingerprint corresponding to the at least one targeted media content item to perform fingerprint matching locally (e.g., using the local database) in order to identify the content of the at least one targeted media content item. Once the targeted media content item is identified, it may be associated with a media application 302.

In some instances, the method 400 can include sending the fingerprint corresponding to the at least one targeted media content item to an automatic content recognition server, and receiving, from the automatic content recognition server, an identification of the at least one targeted media content item. For example, media device 106 can send the fingerprint to ACR server(s) 310. As noted above, ACR server(s) 310 may include a database that can be used to identify the at least one targeted media content item by using the fingerprint (e.g., performing fingerprint matching). The ACR server(s) 310 can send an identifier to media device 106 that can be used to identify the content of the at least one targeted media content item. For instance, the identifier can be used to determine that the at least one targeted media content item corresponds to a solicitation for a commercial for a particular brand of product and/or service.

In some cases, to identify the at least one targeted media content item the method 400 can further include determining, based on the one or more playback properties, a playback duration associated with each of the plurality of media content items; and determining that the playback duration corresponding to the at least one targeted media content item is less than a threshold playback duration. For example, processing system 204 can use metadata 124 to determine playback duration associated with different portions of content 122. In some cases, processing system 204 can determine that the playback duration associated with the portion of content 122 that includes a targeted media content item is less than a threshold playback duration.

In some instances, to identify the at least one targeted media content item the method 400 can further include determining, based on the one or more playback properties, a uniform resource locator (URL) associated with each of the plurality of media content items. For example, processing system 204 can determine a URL for the portion of content 122 that includes a targeted media content item.

In some examples, to identify the at least one targeted media content item the method 400 can further include determining an encryption state for each of the plurality of media content items, wherein the at least one targeted media content item is not encrypted. For instance, processing system 204 can identify an encryption state for different portions of content 122. In some cases, processing system 204 can determine that the portion of content 122 that includes the targeted media content item is not encrypted.

In some aspects, to identify the at least one targeted media content item the method 400 can further include determining that the at least one targeted media content item is not associated with closed caption content. For example, processing system 204 can determine that the portion of content 122 that includes the targeted media content item does not have corresponding closed-caption content.

In some aspects, the method 400 can include sending the fingerprint to a server configured to perform automatic content recognition on the at least one targeted media content item. For example, media device 106 can send the fingerprint obtained by ACR system 306 to ACR servers 310.

In some examples, the method 400 can include disabling automatic content recognition during playback of a remaining portion of the plurality of media content items that does not include the at least one targeted media content item. For instance, media device 106 can disable ACR during playback of content 122 that does not include the targeted media content identified by processing system 204.

In some cases, the method 400 can include receiving an authorization to obtain the fingerprint from the application on the media device. For example, media device 106 can obtain (e.g., via an application processing interface (API)) an authorization to obtain the fingerprint from media applications 302.

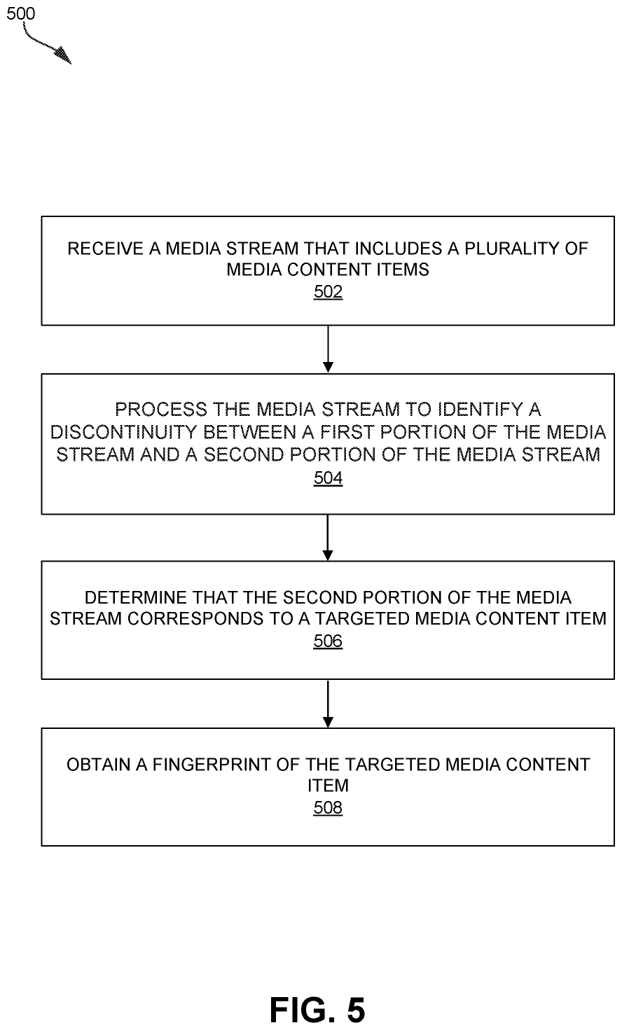

FIG. 5 is a flowchart for a method 500 for optimizing automatic content recognition queries. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIG. 3. However, method 500 is not limited to that example.

In step 502, the method 500 includes receiving a media stream that includes a plurality of media content items. For example, media device 106 can receive content 122 that includes a media stream having a plurality of media content items.

In step 504, the method 500 includes processing the media stream to identify a discontinuity between a first portion of the media stream and a second portion of the media stream. For instance, processing system 204 can process content 122 to identify a discontinuity (e.g., shot break, scene break, unit break, blank frame(s), etc.) within content 122. Alternatively, or in addition, ML model 308 can be trained to identify one or more discontinuities within content 122.

In step 506, the method 500 includes determining that the second portion of the media stream corresponds to a targeted media content item. For example, processing system 204 or ML model 308 can determine that the second portion (e.g., before or after the discontinuity) of content 122 corresponds to a targeted media content item. In some aspects, ML model 308 may identify the targeted media content item based on one or more contextual features obtained from content 122 and/or from metadata 124. In some instances, processing system 204 may identify the targeted media content based on one or more playback properties (e.g., based on metadata 124).

In step 508, the method 500 includes obtaining a fingerprint of the targeted media content item. For example, ACR system 306 can be configured to obtain a fingerprint of the targeted media content item.

In some examples, method 500 can include matching the fingerprint of the targeted media content item with a known fingerprint from a plurality of fingerprints stored on a local database (e.g., within media device 106) or on a remote database (e.g., within ACR server(s) 310). That is, media device 106 may process the fingerprint locally to identify the content of the targeted media content item, or, alternatively, media device 106 may send the fingerprint to a server (e.g., ACR server(s) 310) which may process the fingerprint and return data/information that can be used to identify the targeted media content item. In some aspects, the identified targeted media content item may be associated with a media application 302.

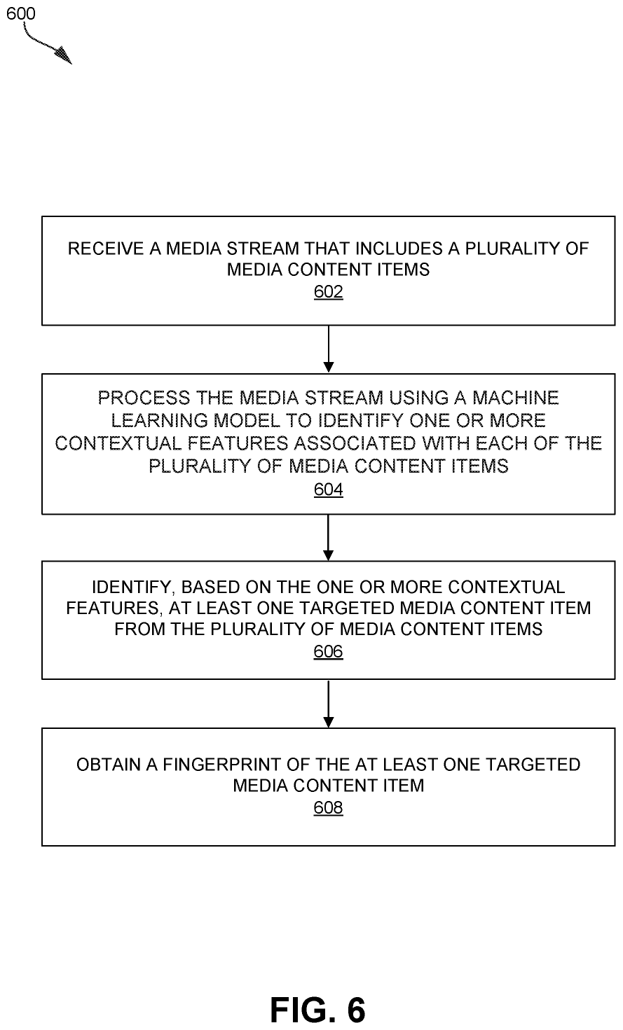

FIG. 6 is a flowchart for a method 600 for optimizing automatic content recognition queries. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIG. 3. However, method 600 is not limited to that example.

In step 602, the method 600 includes receiving a media stream that includes a plurality of media content items. For example, media device 106 can receive content 122 that includes a media stream having a plurality of media content items.

In step 604, the method 600 includes processing the media stream using a machine learning model to identify one or more contextual features associated with each of the plurality of media content items. For instance, ML model 308 can process content 122 and/or metadata 124 to identify one or more contextual features associated with content 122. Contextual features can include a type and/or genre of content, a type of scene, a background and/or setting, any activity and/or events, an actor or actors, demographic information, a mood and/or sentiment, a type of audio or lack thereof, any objects, noise levels, a landmark and/or architecture, a geographic location, a keyword, a message, a type of encoding, a time and/or date, any other characteristic associated with media content 122, and/or any combination thereof.

In step 606, the method 600 includes identifying, based on the one or more contextual features, at least one targeted media content item from the plurality of media content items. For example, ML model 308 can identify, based on the contextual features, a portion of content 122 that includes a targeted media content item.

In step 608, the method 600 includes obtaining a fingerprint of the at least one targeted media content item. For instance, ACR system 306 can obtain a fingerprint from the targeted media content item identified by ML model 308.

In some examples, method 600 can include matching the fingerprint of the at least one targeted media content item with a known fingerprint from a plurality of fingerprints stored on a local database (e.g., within media device 106) or on a remote database (e.g., within ACR server(s) 310). That is, media device 106 may process the fingerprint locally to identify the content of the targeted media content item, or, alternatively, media device 106 may send the fingerprint to a server (e.g., ACR server(s) 310) which may process the fingerprint and return data/information that can be used to identify the targeted media content item. In some aspects, the identified targeted media content item may be associated with a media application 302.

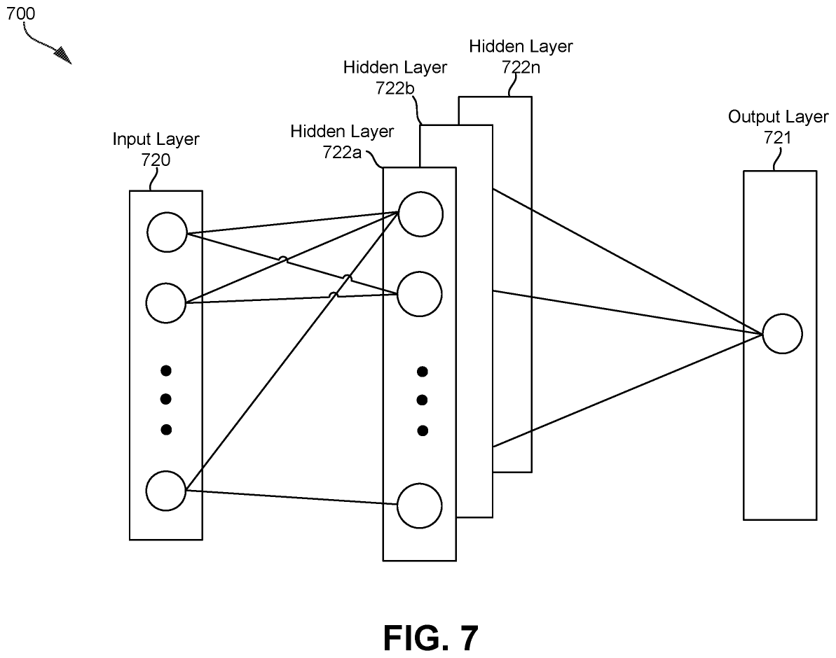

FIG. 7 is a diagram illustrating an example of a neural network architecture 700 that can be used to implement some or all of the neural networks described herein. The neural network architecture 700 can include an input layer 720 can be configured to receive and process data to generate one or more outputs. The neural network architecture 700 also includes hidden layers 722a, 722b, through 722n. The hidden layers 722a, 722b, through 722n include “n” number of hidden layers, where “n” is an integer greater than or equal to one. The number of hidden layers can be made to include as many layers as needed for the given application. The neural network architecture 700 further includes an output layer 721 that provides an output resulting from the processing performed by the hidden layers 722a, 722b, through 722n.

The neural network architecture 700 is a multi-layer neural network of interconnected nodes. Each node can represent a piece of information. Information associated with the nodes is shared among the different layers and each layer retains information as information is processed. In some cases, the neural network architecture 700 can include a feed-forward network, in which case there are no feedback connections where outputs of the network are fed back into itself. In some cases, the neural network architecture 700 can include a recurrent neural network, which can have loops that allow information to be carried across nodes while reading in input.

Information can be exchanged between nodes through node-to-node interconnections between the various layers. Nodes of the input layer 720 can activate a set of nodes in the first hidden layer 722a. For example, as shown, each of the input nodes of the input layer 720 is connected to each of the nodes of the first hidden layer 722a. The nodes of the first hidden layer 722a can transform the information of each input node by applying activation functions to the input node information. The information derived from the transformation can then be passed to and can activate the nodes of the next hidden layer 722b, which can perform their own designated functions. Example functions include convolutional, up-sampling, data transformation, and/or any other suitable functions. The output of the hidden layer 722b can then activate nodes of the next hidden layer, and so on. The output of the last hidden layer 722n can activate one or more nodes of the output layer 721, at which an output is provided. In some cases, while nodes in the neural network architecture 700 are shown as having multiple output lines, a node can have a single output and all lines shown as being output from a node represent the same output value.

In some cases, each node or interconnection between nodes can have a weight that is a set of parameters derived from the training of the neural network architecture 700. Once the neural network architecture 700 is trained, it can be referred to as a trained neural network, which can be used to generate one or more outputs. For example, an interconnection between nodes can represent a piece of information learned about the interconnected nodes. The interconnection can have a tunable numeric weight that can be tuned (e.g., based on a training dataset), allowing the neural network architecture 700 to be adaptive to inputs and able to learn as more and more data is processed.

The neural network architecture 700 is pre-trained to process the features from the data in the input layer 720 using the different hidden layers 722a, 722b, through 722n in order to provide the output through the output layer 721.

In some cases, the neural network architecture 700 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network architecture 700 is trained well enough so that the weights of the layers are accurately tuned.

To perform training, a loss function can be used to analyze an error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network architecture 700 can perform a backward pass by determining which inputs (weights) most contributed to the loss of the network, and can adjust the weights so that the loss decreases and is eventually minimized.

The neural network architecture 700 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network architecture 700 can include any other deep network other than a CNN, such as an autoencoder, Deep Belief Nets (DBNs), Recurrent Neural Networks (RNNs), among others.

As understood by those of skill in the art, machine-learning based techniques can vary depending on the desired implementation. For example, machine-learning schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

### Example Computer System

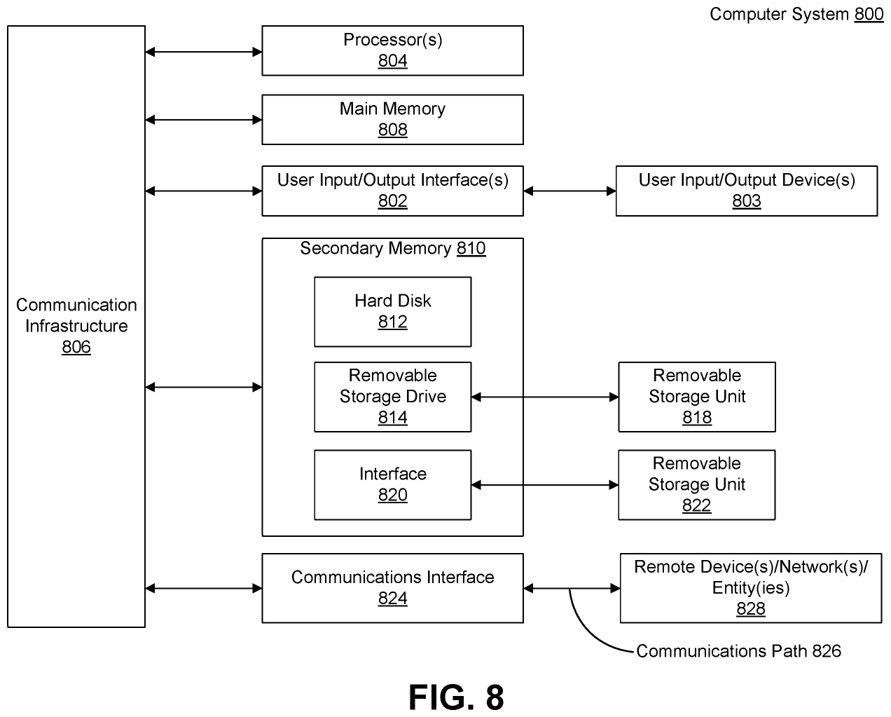

Various aspects and examples may be implemented, for example, using one or more well-known computer systems, such as computer system 800 shown in FIG. 8. For example, the media device 106 may be implemented using combinations or sub-combinations of computer system 800. Also or alternatively, one or more computer systems 800 may be used, for example, to implement any of the aspects and examples discussed herein, as well as combinations and sub-combinations thereof.

Computer system 800 may include one or more processors (also called central processing units, or CPUs), such as a processor 804. Processor 804 may be connected to a communication infrastructure or bus 806.

Computer system 800 may also include user input/output device(s) 803, such as monitors, keyboards, pointing devices, etc., which may communicate with communication infrastructure 806 through user input/output interface(s) 802.

One or more of processors 804 may be a graphics processing unit (GPU). In some examples, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 800 may also include a main or primary memory 808, such as random access memory (RAM). Main memory 808 may include one or more levels of cache. Main memory 808 may have stored therein control logic (e.g., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 may include a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 may read from and/or write to removable storage unit 818.

Secondary memory 810 may include other means, devices, components, instrumentalities or other approaches for allowing computer programs and/or other instructions and/or data to be accessed by computer system 800. Such means, devices, components, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 800 may include a communication or network interface 824. Communication interface 824 may enable computer system 800 to communicate and interact with any combination of external devices, external networks, external entities, etc. (individually and collectively referenced by reference number 828). For example, communication interface 824 may allow computer system xx00 to communicate with external or remote devices 828 over communications path 826, which may be wired and/or wireless (or a combination thereof), and which may include any combination of LANs, WANs, the Internet, etc. Control logic and/or data may be transmitted to and from computer system 800 via communication path 826.

Computer system 800 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 800 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 800 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some examples, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800 or processor(s) 804), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method comprising: receiving metadata corresponding to a media stream requested for playback by an application on a media device, wherein the media stream includes a plurality of media content items; determining, based on the metadata, one or more playback properties associated with the plurality of media content items within the media stream; identifying, based on the one or more playback properties, at least one targeted media content item from the plurality of media content items; determining a playback time for the at least one targeted media content item; and obtaining, during the playback time, a fingerprint corresponding to the at least one targeted media content item.

Aspect 2. The method of Aspect 1, wherein identifying the at least one targeted media content item further comprises: determining, based on the one or more playback properties, a playback duration associated with each of the plurality of media content items; and determining that the playback duration corresponding to the at least one targeted media content item is less than a threshold playback duration.

Aspect 3. The method of any of Aspects 1 to 2, wherein identifying the at least one targeted media content item further comprises: determining, based on the one or more playback properties, a uniform resource locator (URL) associated with each of the plurality of media content items.

Aspect 4. The method of any of Aspects 1 to 3, wherein identifying the at least one targeted media content item further comprises: determining an encryption state for each of the plurality of media content items, wherein the at least one targeted media content item is not encrypted.

Aspect 5. The method of any of Aspects 1 to 4, wherein identifying the at least one targeted media content item further comprises: determining that the at least one targeted media content item is not associated with closed caption content.

Aspect 6. The method of any of Aspects 1 to 5, further comprising: sending the fingerprint to a server configured to perform automatic content recognition on the at least one targeted media content item.

Aspect 7. The method of any of Aspects 1 to 6, further comprising: disabling automatic content recognition during playback of a remaining portion of the plurality of media content items that does not include the at least one targeted media content item.

Aspect 8. The method of any of Aspects 1 to 7, wherein the media stream corresponds to at least one of a dynamic adaptive streaming over HTTP (DASH) format and a HTTP live streaming (HLS) format.

Aspect 9. The method of any of Aspects 1 to 8, further comprising: receiving an authorization to obtain the fingerprint from the application on the media device.

Aspect 10. The method of any of Aspects 1 to 9, wherein the metadata corresponds to a manifest file.

Aspect 11. An apparatus comprising: at least one memory; and at least one processor coupled to the at least one memory, wherein the at least one processor is configured to perform operations in accordance with any one of Aspects 1 to 10.

Aspect 12. An apparatus comprising means for performing operations in accordance with any one of Aspects 1 to 10.

Aspect 13. A non-transitory computer-readable medium comprising instructions that, when executed by an apparatus, cause the apparatus to perform operations in accordance with any one of Aspects 1 to 10.

What is claimed is:

1. A system comprising:
one or more memories; and
at least one processor coupled to at least one of the one or more memories and configured to perform operations comprising:
receive metadata corresponding to a media stream requested for playback by an application on a media device, wherein the media stream includes a plurality of media content items;
determine, based on the metadata, one or more playback properties associated with the plurality of media content items within the media stream;
identify, based on the one or more playback properties, at least one targeted media content item from the plurality of media content items;
determine a playback time for the at least one targeted media content item; and
obtain, during the playback time, a fingerprint corresponding to the at least one targeted media content item.

2. The system of claim 1, wherein to identify the at least one targeted media content item the at least one processor is configured to perform operations comprising:
determine, based on the one or more playback properties, a playback duration associated with each of the plurality of media content items; and
determine that the playback duration corresponding to the at least one targeted media content item is less than a threshold playback duration.

3. The system of claim 1, wherein to identify the at least one targeted media content item the at least one processor is configured to perform operations comprising:
determine, based on the one or more playback properties, a uniform resource locator (URL) associated with each of the plurality of media content items.

4. The system of claim 1, wherein to identify the at least one targeted media content item the at least one processor is configured to perform operations comprising:
determine an encryption state for each of the plurality of media content items, wherein the at least one targeted media content item is not encrypted.

5. The system of claim 1, wherein to identify the at least one targeted media content item the at least one processor is configured to perform operations comprising:
determine that the at least one targeted media content item is not associated with closed caption content.

6. The system of claim 1, wherein the at least one processor is configured to perform operations comprising:
send the fingerprint to a server configured to perform automatic content recognition on the at least one targeted media content item.

7. The system of claim 1, wherein the at least one processor is configured to perform operations comprising:
disable automatic content recognition during playback of a remaining portion of the plurality of media content items that does not include the at least one targeted media content item.

8. The system of claim 1, wherein the media stream corresponds to at least one of a dynamic adaptive streaming over HTTP (DASH) format and a HTTP live streaming (HLS) format.

9. The system of claim 1, wherein the at least one processor is configured to perform operations comprising:
receive an authorization to obtain the fingerprint from the application on the media device.

10. The system of claim 1, wherein the metadata corresponds to a manifest file.

11. A computer-implemented method for processing media content, the computer-implemented method comprising:
receiving metadata corresponding to a media stream requested for playback by an application on a media device, wherein the media stream includes a plurality of media content items;
determining, based on the metadata, one or more playback properties associated with the plurality of media content items within the media stream;
identifying, based on the one or more playback properties, at least one targeted media content item from the plurality of media content items;
determining a playback time for the at least one targeted media content item; and
obtaining, during the playback time, a fingerprint corresponding to the at least one targeted media content item.

12. The computer-implemented method of claim 11, wherein identifying the at least one targeted media content item further comprises:
determining, based on the one or more playback properties, a playback duration associated with each of the plurality of media content items; and
determining that the playback duration corresponding to the at least one targeted media content item is less than a threshold playback duration.

13. The computer-implemented method of claim 11, wherein identifying the at least one targeted media content item further comprises:
determining, based on the one or more playback properties, a uniform resource locator (URL) associated with each of the plurality of media content items.

14. The computer-implemented method of claim 11, wherein identifying the at least one targeted media content item further comprises:
determining an encryption state for each of the plurality of media content items, wherein the at least one targeted media content item is not encrypted.

15. The computer-implemented method of claim 11, wherein identifying the at least one targeted media content item further comprises:
determining that the at least one targeted media content item is not associated with closed caption content.

16. The computer-implemented method of claim 11, further comprising:
sending the fingerprint to a server configured to perform automatic content recognition on the at least one targeted media content item.

17. The computer-implemented method of claim 11, further comprising:
disabling automatic content recognition during playback of a remaining portion of the plurality of media content items that does not include the at least one targeted media content item.

18. The computer-implemented method of claim 11, wherein the media stream corresponds to at least one of a dynamic adaptive streaming over HTTP (DASH) format and a HTTP live streaming (HLS) format.

19. The computer-implemented method of claim 11, further comprising:
receiving an authorization to obtain the fingerprint from the application on the media device.

20. A non-transitory computer-readable medium having instructions stored thereon that, when executed by at least one computing device, cause the at least one computing device to perform operations comprising:
receive metadata corresponding to a media stream requested for playback by an application on a media device, wherein the media stream includes a plurality of media content items;
determine, based on the metadata, one or more playback properties associated with the plurality of media content items within the media stream;
identify, based on the one or more playback properties, at least one targeted media content item from the plurality of media content items;
determine a playback time for the at least one targeted media content item; and
obtain, during the playback time, a fingerprint corresponding to the at least one targeted media content item.
